(19) United States
(12) Patent Application Publication
(10) Pub. No.: US 2014/0290003 A1
(43) Pub. Date: Oct. 2, 2014

(54) HINGE MECHANISM FOR PIVOTABLE DOOR

(71) Applicant: G.S. Blodgett Corp., Burlington, VT (US)

(72) Inventors: Brian C. Mick, Burlington, VT (US); Daniel J. Swayze, Colchester, VT (US)

(73) Assignee: G.S. Blodgett Corp., Burlington, VT (US)

(21) Appl. No.: 14/165,019

(22) Filed: Jan. 27, 2014

Related U.S. Application Data
(60) Provisional application No. 61/759,020, filed on Jan. 31, 2013.

(51) Int. Cl. E05D 15/28

(52) U.S. Cl. CPC E05D 15/28
USPC 16/277

(57) ABSTRACT

A hinge system for a pivotable door is provided. The system includes a rod extending between a first end portion and a second end portion and a restraint receiving the second portion of the rod therein with the first end portion of the rod extending through an end cap on the restraint. A biasing member is disposed within the restraint between the end cap and the second end portion of the rod, wherein the biasing member is in a compressed configuration within the restraint, and wherein the first end portion of the rod is operatively engaged with a door pivotably secured to the cooking appliance, and the restraint is pivotably connected to the cooking appliance.

### CROSS-REFERENCE TO RELATED APPLICATIONS

This application claims priority from U.S. Provisional Application No. 61/759,020, filed on Jan. 31, 2013, the entirety of which is hereby fully incorporated by reference herein.

### TECHNICAL FIELD

This disclosure is directed to a system to pivotably mount a door to a cooking appliance.

### BRIEF SUMMARY

A representative embodiment of the disclosure provides a door movement system for use with a cooking appliance. The system includes a rod extending between a first end portion and a second end portion and a restraint receiving the second portion of the rod therein with the first end portion of the rod extending through an end cap on the restraint. A biasing member is disposed within the restraint between the end cap and the second end portion of the rod, wherein the biasing member is in a compressed configuration within the restraint, and wherein the first end portion of the rod is operatively engaged with a door pivotably secured to the cooking appliance, and the restraint is pivotably connected to the cooking appliance.

Another representative embodiment of the disclosure is provided. The embodiment includes a door movement system for use with a cooking appliance. The system includes a rod extending between a first end portion and a second end portion. A restraint receives the second portion of the rod therein with the first end portion of the rod extending through an end cap of the restraint. A biasing member disposed within the restraint between the end cap and the second end portion of the rod, wherein the biasing member is in a compressed configuration within the restraint, and wherein the first end portion of the rod is operatively engaged with a door pivotably secured to the cooking appliance, and the door is pivotably connected to the cooking appliance. A bracket is fixed to a housing of the cooking appliance, and a second rod pinned to the bracket, wherein the second rod is engaged with an end of the restraint, such that relative rotation between the second rod and the restraint changes a distance of the end of the restraint from the pinned connection with the bracket. The door is pivotable with respect to the cooking appliance between a first closed position where the door is in a substantially vertical position and an open position where the door is in a substantially horizontal position, wherein the door passes through an intermediate position when the door pivots between the open and closed positions, wherein the door is biased to move toward the closed position after pivoting past the intermediate position toward the closed position, and the door is biased toward the open position after pivoting past the intermediate position toward the open position, and wherein the door may be maintained in a stationary position in the intermediate position.

Other embodiments of the disclosure will become apparent in view of the following description taken in connection with the accompanying drawings.

### BRIEF DESCRIPTION OF THE DRAWINGS

FIG. 1 is perspective view of a hinge mechanism for a door, showing the door in an open position.

FIG. 2 is the view of FIG. 1, with the door in a closed position.

FIG. 3 is a side view of the mechanism of FIG. 1, showing the door in an open position.

FIG. 4 is the view of FIG. 3, with the restraint shown in a sectional view.

FIG. 5 is the view of FIG. 3, showing the door in a closed position.

FIG. 6 is the view of FIG. 5, with the restraint shown in a sectional view.

FIG. 7 is the view of FIG. 3, showing the door in an intermediate position.

FIG. 8 is an exploded view of the components of the hinge mechanism.

FIG. 9 is a perspective view of an oven with hinge mechanism (with the outer panel of the oven removed), showing the door in the open position.

FIG. 10 is the view of FIG. 9, showing the door in the intermediate position.

FIG. 11 is a side view of a second restraint mechanism showing the door in the closed position.

FIG. 12 is the view of FIG. 11 showing the door in the open position.

FIG. 13 is the view of FIG. 11 showing the door in the intermediate position.

FIG. 14 is an exploded view of the second restraint mechanism.

### DETAILED DESCRIPTION OF THE DRAWINGS AND THE PRESENTLY PREFERRED EMBODIMENTS

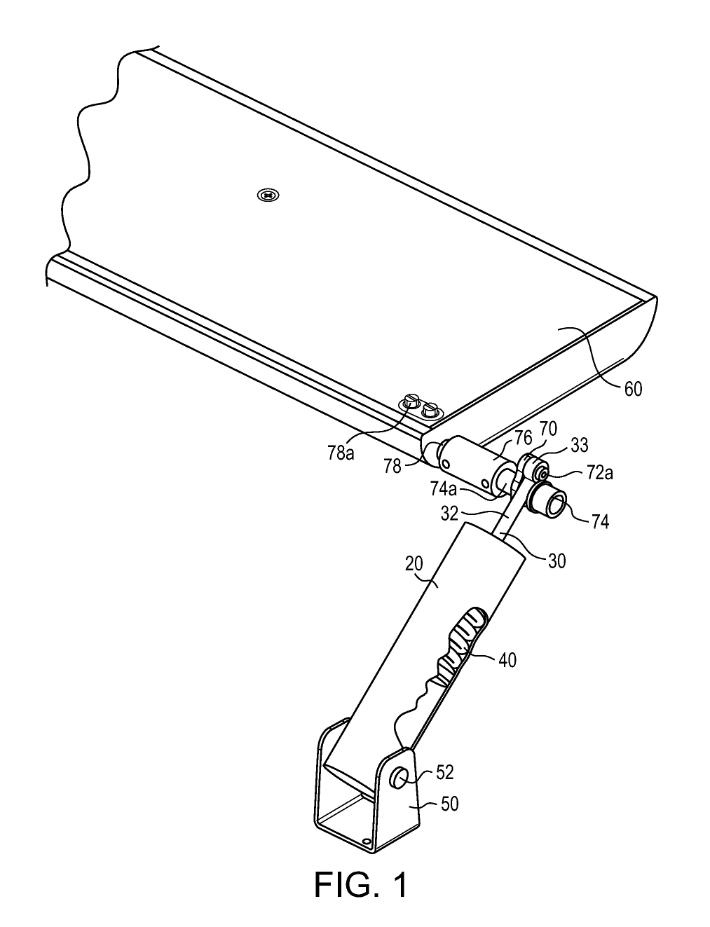

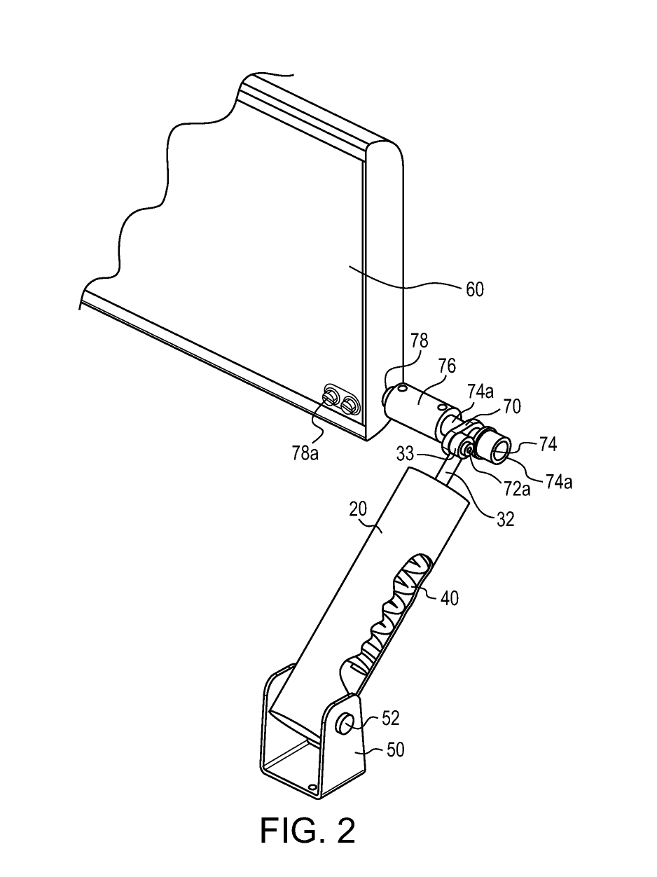

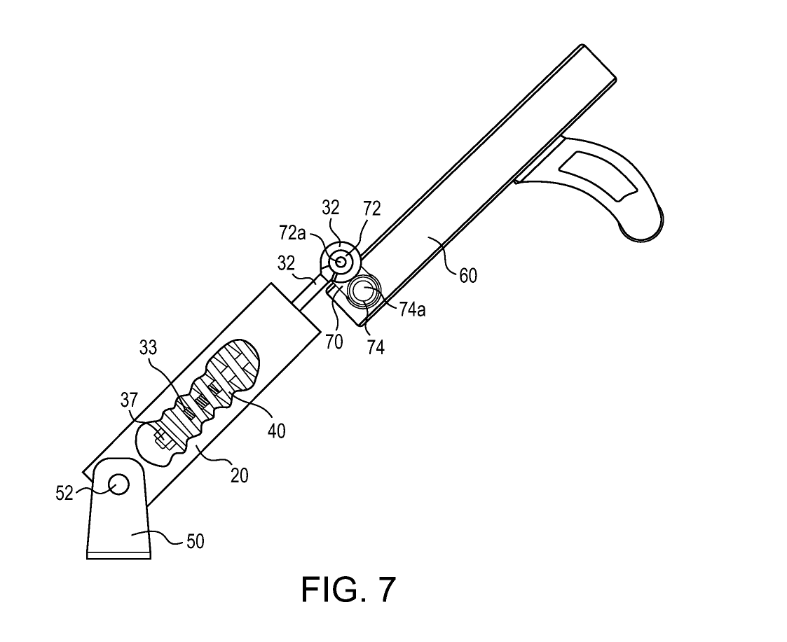

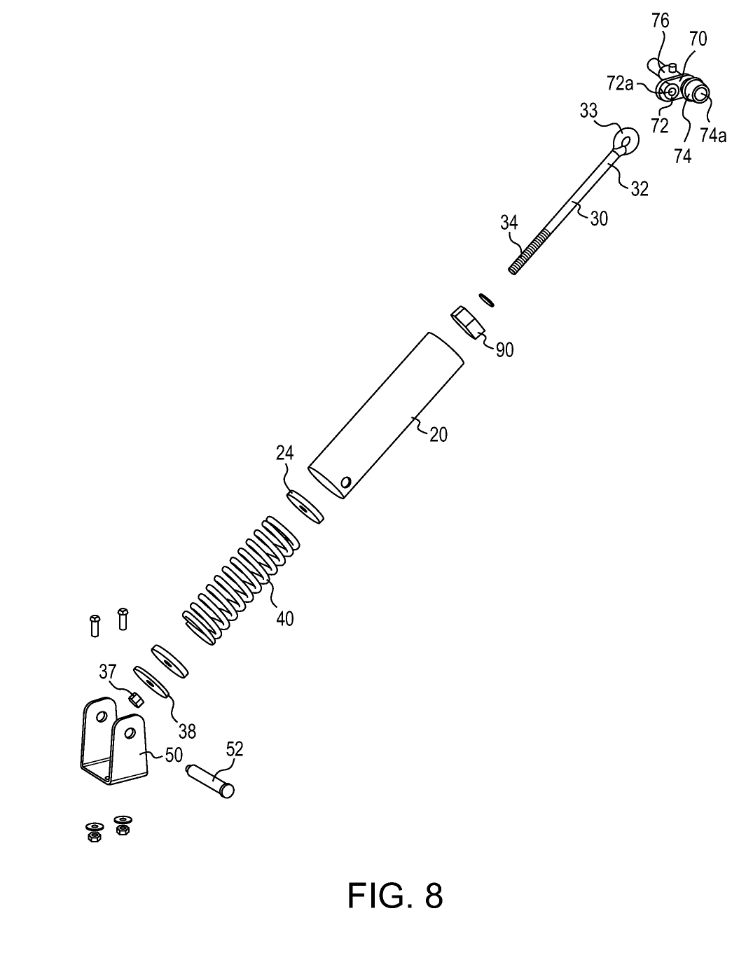

Turning now to FIGS. 1-10, a hinge mechanism 10 for a pivotable door 60 is provided. The hinge mechanism 10 may be provided to pivotably connect a door 60 to a housing 2 of an oven, such as a deck, or pizza oven 1. The hinge mechanism 10 is configured to be biased toward a closed position (FIGS. 2, 5, 6) with a spring 40 (such as a helical compression spring or other type of biasing member) that is disposed in conjunction with a hinge assembly on one or both sides of the door 60. The hinge mechanism 10 is additionally configured to allow the door 60 to open toward the open position (FIGS. 1, 3, 4) as the door 60 pivotably approaches the open position due to the force of gravity acting on the door 60. As shown in FIG. 7, the door 60 may be maintained at an intermediate position between the open and closed position, where the force within the hinge mechanism 10 that urges the door toward the closed position is balanced with the opening force upon the door due to the force of gravity acting upon the door's center of mass. In some embodiments, the door 60 may be pivotably mounted to the housing 2 of the oven 1 with a single hinge mechanism 10 on one side of the door 60 and a pinned connection between the door 60 and the other side of the housing 2, while in other embodiments, the door 60 is mounted to the housing 2 with hinge mechanisms 10 on both sides of the door 60.

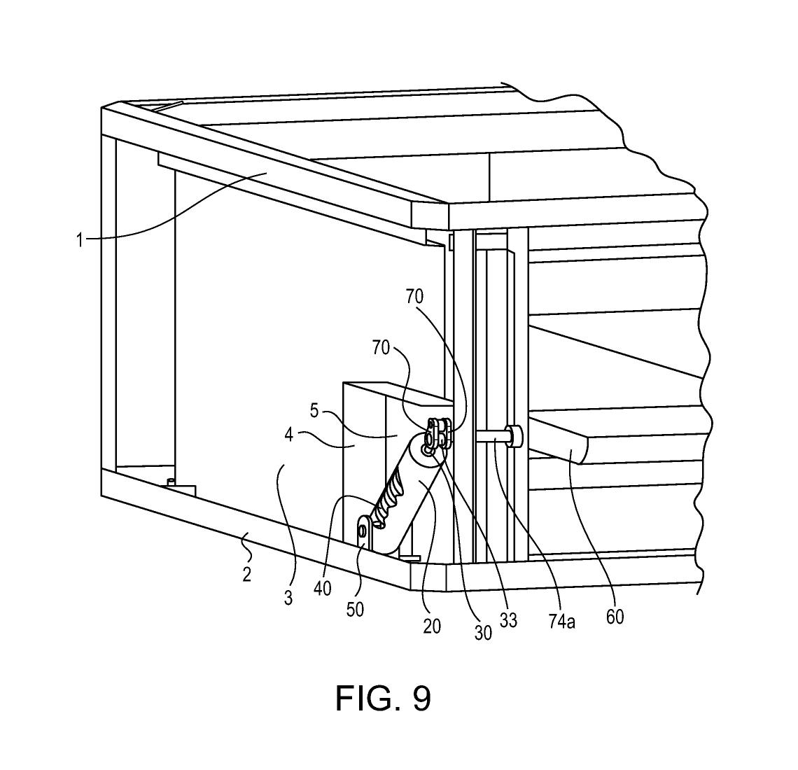

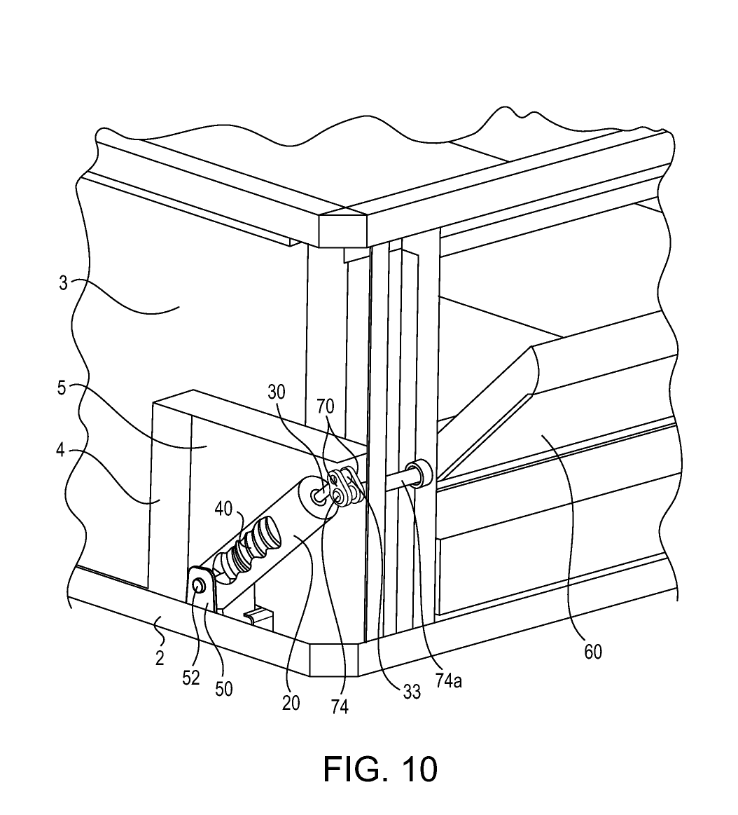

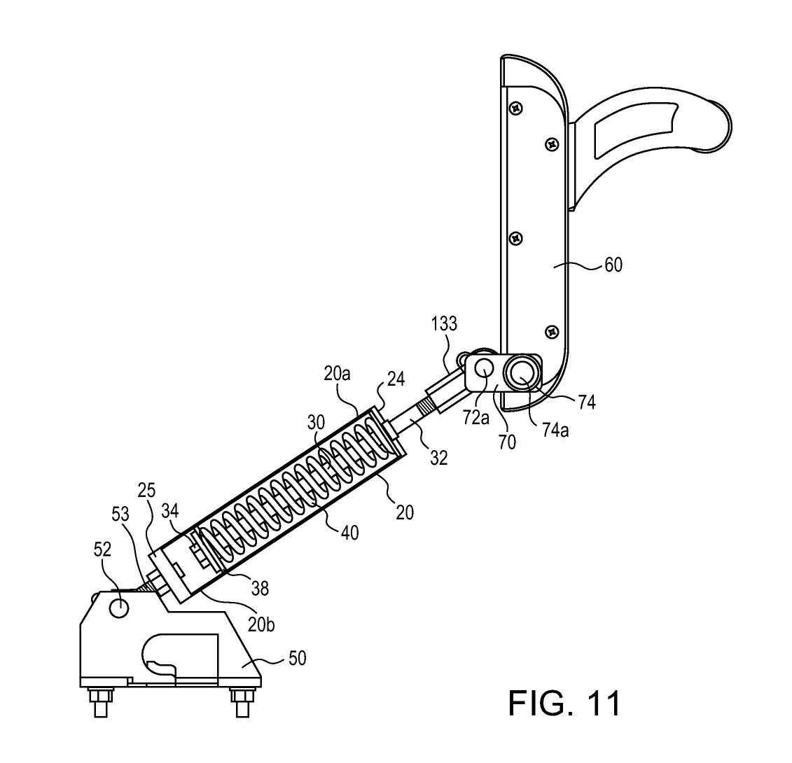

The oven 1 that supports the door 60 may be a deck oven (as shown in FIGS. 9-10), but it will be readily understood by one of ordinary skill in the art reviewing this specification that any mechanical structure that pivotably supports a door or other structure between a vertical orientation (where the center of mass of the door is located substantially above the pivot point where the door is connected to the housing of the mechanical structure) and an open position where the door 60 is pivoted to an open position may include the hinge mechanism 10. The oven 1 is formed by a housing 2 supporting a plurality of walls 3. The walls 3 are provided for separating the cooking compartment from the mechanical structures that generate the heat for cooking as well as separating the pivoting mechanism 10 from the cooking compartment. As best shown in FIGS. 9 and 10, the pivoting mechanism may be disposed within an enclosed volume 5 by walls 4 to prevent the moving components of the mechanism 10 to be fouled by cooking grease or being interfered with by other portions of the housing 2. In some embodiments, the enclosed volume between the walls 4 and the walls 3 may be insulated to allow for the temperature of the components of the mechanism 10 to be decreased to prevent high temperatures from providing a significant design constraint on the components of the mechanism (within the enclosed volume 5) and to prevent insulation from restricting the movement of the mechanism.

The hinge mechanism 10 includes an elongate rod 30 that extends between a first end portion 32 and a second end portion 34. The first end portion 32 may include an eye bolt 33 or similar structure to receive or connect to a bearing 72 and a first pin 72a therethrough. The second end portion 34 of the rod 30 may be threaded. The second end portion 34 of the rod 30 is received within a restraint, such as a cylinder, or other partially or fully closed structure that is capable of receiving a portion of the rod 30 and spring 40 (discussed below) therein, with the first end portion 32 of the rod 30 extending through an aperture in an end cap 24 fixed to the restraint 20. The restraint 20 is pivotably mounted within the housing 2 of the oven 1 with pinned connection 52 to a bracket 50 that is fixed to the housing 2.

A spring 40, such as a helical spring, or other type of biasing member, is disposed within the restraint 20 and disposed between the end cap 24 and a bearing surface 38 or such as a washer disposed around the second end portion 34 of the rod 30. In some embodiments, a nut 37 is threaded upon the second end portion 34 of the rod 30, and as can be appreciated, the position of the nut 37 upon the second end portion 34 of the rod 30 alters the amount of compression of the spring 40 because movement of the nut 37 up the length of the rod 30 causes the bearing surface 38 to similarly move.

The spring 40 is disposed within the restraint 20 in a compressed configuration, where the length of the spring 40 is less than its normal length when unconstrained. The compressed configuration of the spring 40 causes the spring to press against the bearing surface 38 upon the rod 30, which pulls the rod 30 in a direction where the first end portion 32 is urged toward the restraint 20.

The first end portion 32 of the rod 30 is pivotably fixed to a bar 70, which may be formed with two apertures disposed upon opposite ends thereof. A pin 72a may extend through a first hole in the bar, which also extends through a first bearing 72. The first bearing 72 may be connected to the first end portion 32 of the rod 30, such as within the eye bolt 33, when provided upon the first end portion 32 of the rod 30.

The bar 70 may receive or be fixed to the second pin 74a that is rigidly connected to the bar 70 to prevent relative pivoting or rotation therebetween. The second pin 74a is additionally connected to the door 60 (either directly or indirectly) such that pivoting of the door 60 with respect to the housing 2 causes similar pivoting of the second pin 74a and the bar 70. One or more bearings 74 are fixed with the housing 2 to support the second pin 74a (and structures fixed to the second pin 74a) for pivoting with respect to the housing 2.

In some embodiments, the second pin extends from the bar 70 and into the door 60, while in other embodiments, the second pin 74a is fixed to the bar with a coupling 76, as shown in FIGS. 1 and 2. In some embodiments, as best shown in FIGS. 1 and 2, the door may include a hinge pin 78 that is rigidly mounted to the door (such as with multiple fasteners 78a), and is received within the coupling 76, with the coupling 76 also receiving the second pin 74a to allow the second pin 74a and the hinge pin 78 (and therefore the door 60) to pivot as a single unit.

In some embodiments, two bars 70 may be provided, with each bar 70 disposed on opposite sides of the eye bolt 33, or similar structure upon the first end portion 32 of the rod 30. Embodiments with two bars 70 provide the same functionality, but with added strength against shear or other types of failure of the bar 70. In other embodiments, the bar 70 may be manufactured with a larger thickness or of a relatively stronger material to achieve the added strength provided by two bars 70.

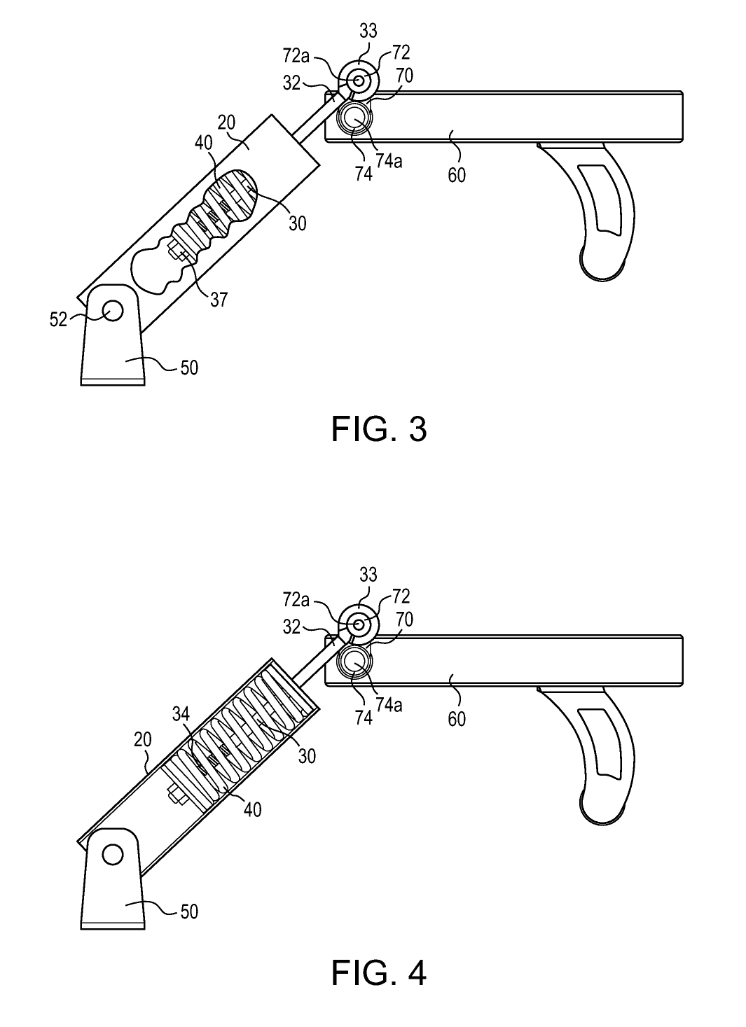

As can be best seen with reference to FIGS. 3-6, the position of the bar 70 and specifically the axis through the second hole and the second pin 74a is fixed due to the constraint provided between the second pin 74a (or combination of second pin 74a and hinge pin 78) with one or more apertures through which the second pin 74a extends through one or more structural members of the housing 2 (in some embodiments constrained by bearings fixed to the housing 2) of the oven 1. The first pin 72a and the eye bolt 33 of the rod 30 (as constrained with respect to the second pin 74a by the bar 70) therefore orbits about the pivotably fixed second pin 74a (as understood when comparing FIGS. 3, 5, and 7) as the door is urged to pivot, for example from the closed position through the intermediate position and to the open position, or when the door 60 is urged from the closed position to the intermediate position and then allowed to pivot from the intermediate position to the closed position.

The constraint of the second pin 74a further constrains the door 60 to only allow for a pivoting motion of the door 60 with respect to the frame 2. The motion of the door 60 may be further constrained by the frame 2, such that the door 60 can pivot to a closed, vertical position (FIG. 2) wherein the door 60 blocks the opening in the frame 2 to seal the heat of the oven 1 within the cooking volume, and to an open, horizontal position (FIG. 1) where the door 60 allows complete access to the cooking volume. In some embodiments, there may be an arm attached to the door 60 in some fashion to prevent the door 60 from pivoting past the horizontal position. In other embodiments, the second pin 74a may be keyed within a bearing or a complementary keyed surface upon the housing 2 to prevent the door 60 from pivoting downwardly past the horizontal, open, position.

As mentioned above, the spring 40 is disposed within the restraint 20 in a compressed configuration, with opposite ends of the spring 40 bearing against the end cap 24 of the restraint 20 and a washer or other bearing surface 38 that is connected to the rod 30. The compressed nature of the spring 40 continuously urges the rod 30 into the restraint 20, which pulls the first end portion 32 and eye bolt 33 toward the restraint 20 (although the eye bolt 33 may be prevented from entering the restraint 20 due to the small diameter of hole through the end cap 24). The biasing force of the spring 40 urges the rod 30 into the restraint 20, while the rod 30 feels an opposite force (acting on the rod 30 by way of the bar 70 and pins connecting the rod 30 to the bar 70) due to the torque of the door 60 that is transferred through the second pin 74a and to the bar 70 that is rigidly fixed to the second pin 74a. The opposite force upon the rod 30 is due to the force applied to the door 60 by the user to pivot the door 60 open as well as the increasing torque produced by the door 60 as it is further pivoted open due to the increasing distance of the door's center of mass away from the longitudinal axis of the second pin 74a, which further increases the moment forces of the door 60.

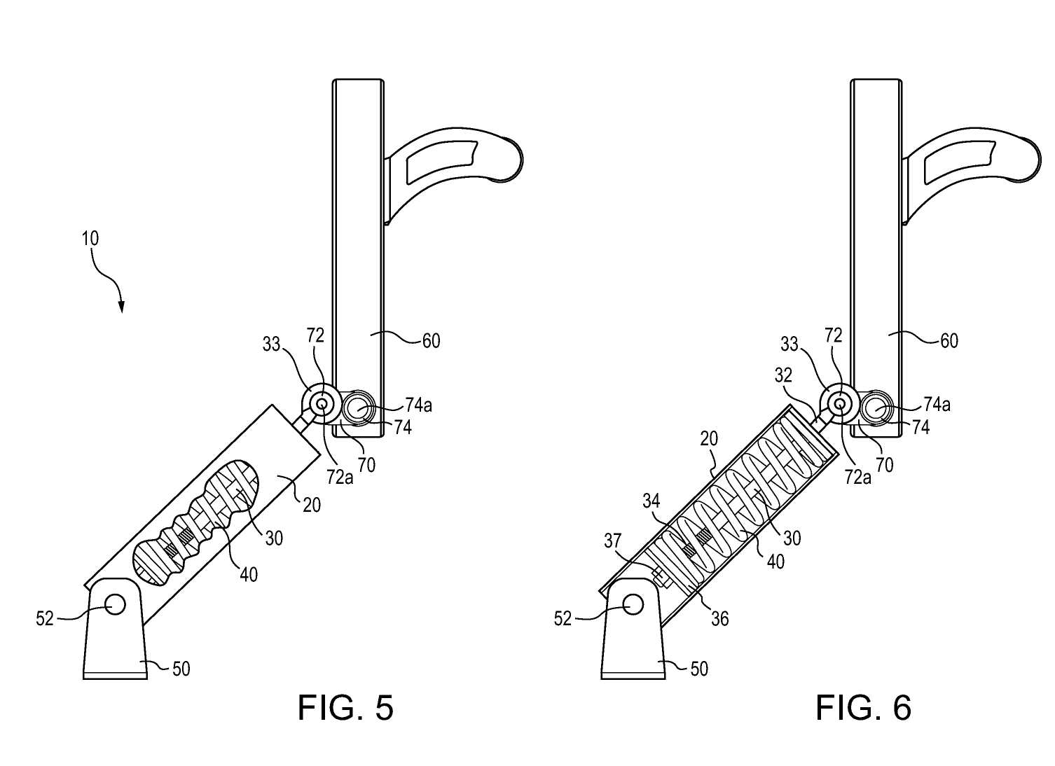

Specifically, as the door 60 pivots, e.g. from the closed position (FIG. 5) through the intermediate position (FIG. 7) and ultimately to the open position (FIG. 3), the simultaneous pivoting of the second pin 74a and the bar 70 causes the eye bolt 33 of the rod 30 (as pivotably fixed to the bar 70) to orbit about the second pin 74a from an initial position where the eye bolt 33 and the second pin 74a are close to being aligned horizontally to a final position where the eye bolt 33 and the second pin 74a are close to being aligned vertically. The orbiting motion from the closed position to the open position (of the door 60) urges the rod 30 in a direction out of the restraint 20, which further compresses the spring 40 because the bearing surface 38 of the rod 30 translates within the restraint 20 with the motion of the rod 30 and the end cap 24 of the restraint 20 is fixed. This further compression of the spring 40 increases the force of the spring 40, which can be calculated with a knowledge of the spring 40 constant, the overall free length of the spring 40, and the amount of compression of the spring 40.

The increased force of the spring 40 as it is further compressed provides an increasing resistance to pivoting of the bar 70 and the second pin 74a to counteract the “opening” force felt by the door 60. In situations where the only force felt by the door 60 is based upon the moment created upon the door 60 by its center of mass (i.e. where the user does not apply any force to the door 60 to pivot it in the opening direction), the force of the compression spring 40 may become balanced with the force created by the moment upon the door 60 at some intermediate position (FIG. 7), where the door 60 will be retained at a position between the open and closed positions.

One of ordinary skill in the art, with a comprehensive review of this specification and the related drawings, will understand that the intermediate position of the door 60 (where it remains stationary between the closed position and the open position) is a function of several factors in the design of the door, for example, the size and mass of the door 60 (and the location of the center of mass upon the door 60 with respect to the second pin 74a, the spring constant, the uncompressed length of the spring 40, the amount of spring compression with the door closed, the geometry of the bar 70, etc.). One of ordinary skill in the art will understand that a selection of these variables and a geometric design of the length of the rod 30 and the size and shape of the bar 70 can alter where the intermediate position of the door 60, and one of ordinary skill in the art would be able to select the appropriate design for to achieve a desired intermediate point with an understanding of this disclosure.

One of ordinary skill in the art would understand that the torque the door 60 exerts increases sinusoidally in proportion to the sine of an angle between the door 60 and the vertical position, starting from a torque of nearly zero at the closed position when the center of mass of the door 60 is substantially above the longitudinal axis of the second pin 74a and increasing to the maximum value when the door 60 is open at the horizontal position and the center of mass of the door 60 is the furthest horizontal distance from the pivoting point of the second pin 74a. One of ordinary skill in the art would further understand that the movement of the rod 30 is constrained by the geometry of the arm 70 and thus can be calculated using trigonometry.

The force exerted by the spring 40 is thusly proportional to the movement of the rod 30 because of the constraints of the hinge mechanism 10. The torque exerted by the system containing the spring 40 and the door 60 pivoting about the second pin 74a is calculated in the standard manner of force multiplied by distance multiplied by the sine of the angle between the rod 30 and the arm 70 (more precisely the angle of the line drawn through the centers of pins 74a and 72a which may or may not be parallel to the arm 70).

As a result, from the chosen geometry of the arm 70 and other constraints or fixed values the net torque on the door 60 can be calculated. In this system the geometry of the arm 70 is carefully chosen to have a resultant torque on the pin 74a which increases at a slower rate than the resultant torque of the door 60 on the pin 74a. As a result there becomes an intermediate point where the magnitude of the two opposing torques are equal and the door 60 will remain balanced without operator input. At a position more nearly vertical the door 60 is biased towards the fully vertical position due to the torque resultant from the spring 40 on the pin 74a being greater than the torque resultant from the door 60 on the pin 74a, and at a position more nearly horizontal the door 60 is biased towards the fully horizontal position due to the torque resultant from the spring 40 on the pin 74a being less than the torque resultant from the door 60 on the pin 74a. For example, in some embodiments, the hinge mechanism 10 and the door 60 may be arranged to produce an intermediate position where the door 60 is oriented at an angle (measured between the horizontal and a plane through the inner surface of the door 60) that is at an angle between 15 degrees and about 45 degrees. The upper end of the range is selected to maximize the access of the cooking compartment when the door is in the intermediate position, and the lower limit has been found to be the lower angle where the door 60 “feels” light to the user. In other embodiments, the optimum intermediate position is at an angle between about 35 degrees and about 45 degrees, which has been considered by the inventors to provide the greatest “feel” to the user when opening the door, such as measured by the relative little amount of force needed to be applied by the user to close the door 60, while still providing a door 60 that is reliably maintained in the open position when desired. In other embodiments, the intermediate position may be considered to be optimum when in a range of about 15 degrees to about 25 degrees, which may be considered optimum because this range provides for ease of access to the cooking compartment when in the intermediate position, and minimizes the amount of force needed by the user to pivot the door 60 from the horizontal, open position through the intermediate position (with the force of the spring 40 urging the door 60 closed after the door pivots past the intermediate position).

In some embodiments, the mechanism 10 may be assembled upon the housing 2 and attached to the door 60 (by way of the second pin 74a) with a spacer 90 (FIG. 8) disposed between the eyebolt 33 and the end cap 24 of the restraint 20. The spacer 90 establishes sufficient play within the rod 30 to allow for ease of assembly of the rod 30 (with the first pin 72 extending through the eyebolt 33) to the second pin 74a. Once this connection is made, the spacer 90 is removed and discarded and the mechanism 10 is ready for use.

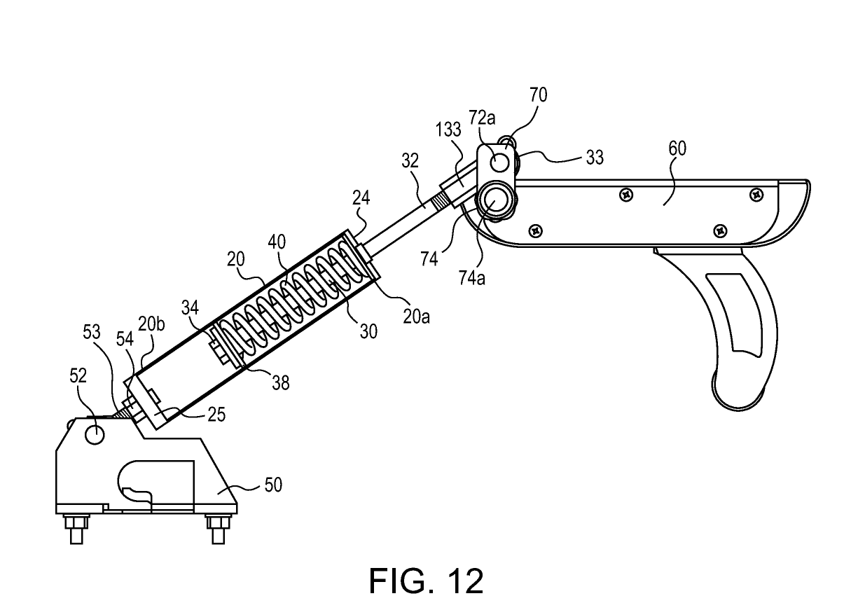

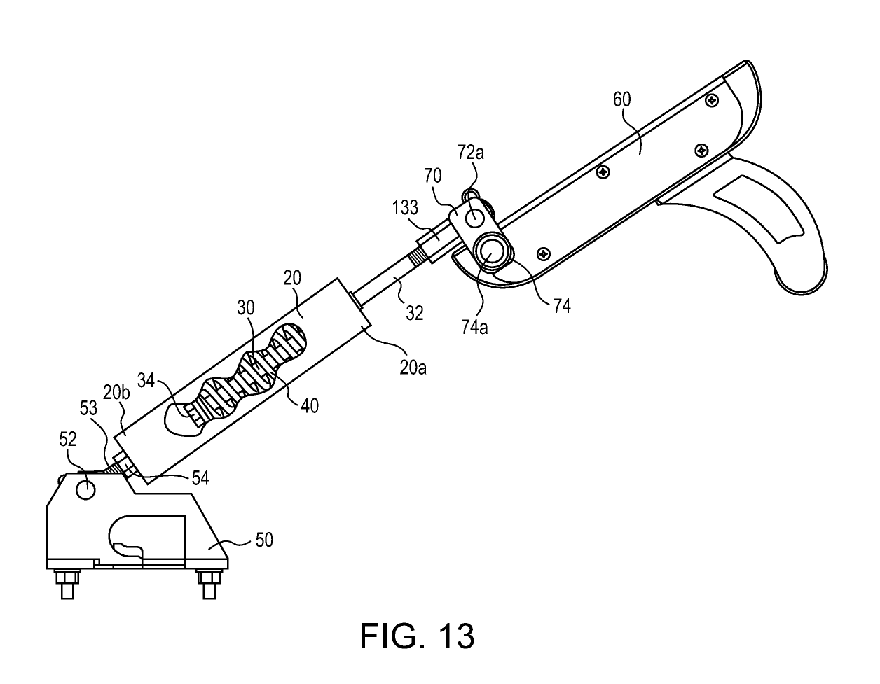

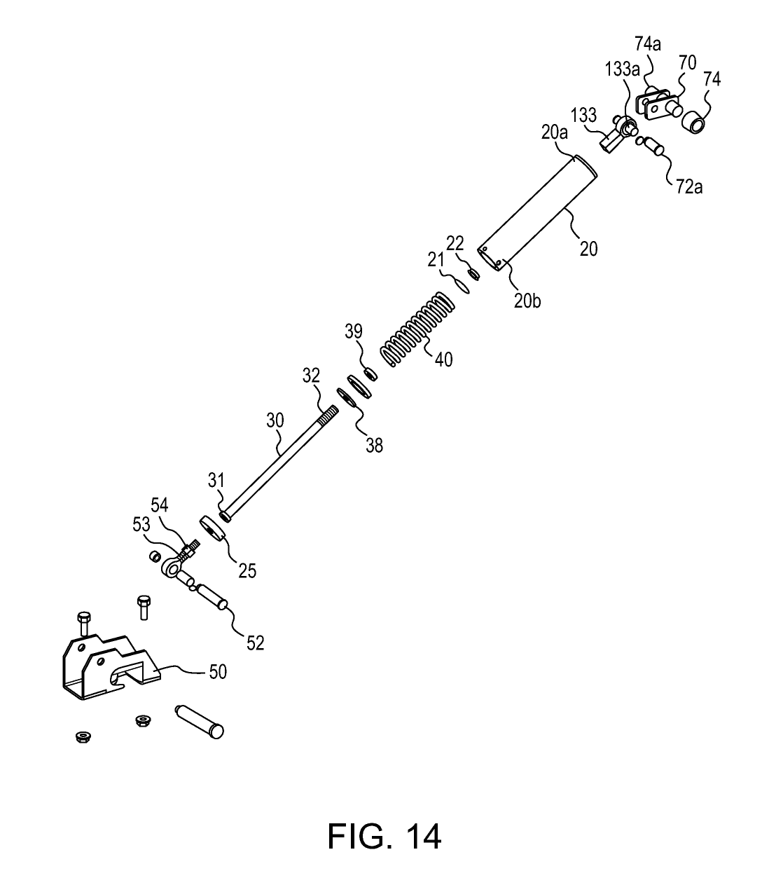

Turning now to FIGS. 11-14, a second mechanism 100 may be provided and assembled upon the housing 2 and attached to the door 60 to rotatably support the door 60 and to allow the door 60 to be maintained in an equilibrium stationary position at an intermediate position, and to be biased toward the closed position (FIG. 11) when rotated above the intermediate position (FIG. 13), and to allow the door to pivot to the open position (FIG. 12) after rotating below the intermediate position due to the force of gravity acting upon the door 60. The mechanism 100 is constructed with many similar or the same components as mechanism 10, discussed above and operates in generally the same manner as discussed with respect to the mechanism 10 discussed above. For the sake of brevity, the components of the second mechanism 100 that were described with respect to the mechanism 10 will be identified with the same element numbers as used for the mechanism 10, above, and will not be discussed in detail here except for any differences specifically noted below.

As shown in FIG. 13, and similar to the depiction of mechanism 10 in FIG. 7, the door 60 may be maintained at an intermediate position between the open and closed position, where the force within the hinge mechanism 100 that urges the door 60 toward the closed position (FIG. 11) is balanced with the opening force upon the door due to the force of gravity acting upon the door's center of mass. The ranges of the selected intermediate positions may be the same as the ranges of the selected intermediate positions discussed above with respect to the mechanism 10, and the basis for and the mechanics of the intermediate position is the same as with the mechanism 10, taking into account the difference in the adjustment of mechanism 100 to modify the intermediate position discussed below.

In some embodiments, the door 60 may be pivotably mounted to the housing 2 of the oven 1 with a single hinge mechanism 100 on one side of the door 60 and a pinned connection between the door 60 and the other side of the housing 2, while in other embodiments, the door 60 is mounted to the housing 2 with hinge mechanisms 100 on both sides of the door 60.

The hinge mechanism 100 includes an elongate rod 30 that extends between a first end portion 32 and a second end portion 34. The first end portion 32 may include an eye bolt 133 with an eye 133a that connects to a bearing 72 and a first pin 72a therethrough. The eye bolt 133 may be fixed to the rod 30 with a threaded connection for ease of assembly. In some embodiments, the threaded connection is fixed to prevent adjustment after the threaded connection is made. The second end portion 34 of the rod 30 is received within a restraint, such as a cylinder 20, or other partially or fully closed structure that is capable of receiving a portion of the rod 30 and spring 40 therein, with the first end portion 32 of the rod 30 extending through an aperture in an end cap 24 fixed to the restraint 20. The first end portion 32 of the rod may extend through an aperture in an end cap 21 and may be supported by one or more bearings 22 and an alignment collar 39.

A second end 20b of the restraint 20 may be fixed to a cap 25 with a threaded hole therethrough. A second rod 53 that includes a threaded end portion is engaged with the threaded hole of the cap 25, and an opposite end of the second rod 53 is rotatably mounted to a bracket 50, such as with an eye 53b that receives a pin 52, which is rotatably mounted to the bracket 50. The pinned connection between the bracket 50 and the second rod 53 allows the restraint 20 to pivot about the bracket 50 and therefore the housing 2, and the threaded connection between the second rod 53 and the restraint 20 allows the linear position of the restraint 20 with respect to the housing 2 to be modified by rotating the restraint 20 with respect to the second rod 53, which changes the distance from the second end 20b of the restraint 20 and the pin 52 through the bracket 50. A locking nut 54 may be provided to fix the position between the restraint 20 and the second rod 53. Because the relative position of the first end 20a of the restraint 20 with respect to the pivot point of the second pin 74a is adjustable (by way of adjustment between the restraint 20 and the second rod 53) and the length of the rod 30 is fixed, the initial compression of the spring 40 within the restraint 20, and therefore the intermediate position of the door 60, may be modified by changing the linear relationship between the restraint 20 and the frame 2 by rotating the restraint 20 with respect to the second rod 53.

As with the mechanism 10, the spring 40 is disposed within the restraint 20 and disposed between the end cap 24 and a bearing surface 38, such as a washer disposed around the second end portion 34 of the rod 30. In some embodiments, the second end of the rod 30 may include a head 34, upon which the washer 38 rests. As can be understood with comparison of mechanisms 10 and 100, the initial spring tension is adjusted with mechanism 10 by adjusting the relative position of the nut 37 (which adjusts the position of the bearing surface 38 upon the second end portion 34 of the rod 30), while in the second mechanism 100, the spring tension is adjusted by adjusting the relative position of the second end portion 20b of the restraint 20 with respect to the threaded second rod 53 by rotating the restraint with respect to the threaded second rod 53 (which is pinned to the bracket 50 and ultimately the frame 2) which changes the position of the bearing surface upon the first end 20a of the restraint 20 with respect to the rod 30.

While the preferred embodiments have been described and illustrated in detail, it is to be understood that this is intended by way of illustration and example only, the scope of the invention being limited by the terms of the following claims.

1. A door movement system for use with a cooking appliance, comprising:
a rod extending between a first end portion and a second end portion;
a restraint receiving the second portion of the rod therein with the first end portion of the rod extending through an end cap of the restraint;
a biasing member disposed within the restraint between the end cap and the second end portion of the rod, wherein the biasing member is in a compressed configuration within the restraint, and wherein the first end portion of the rod is operatively engaged with a door pivotably secured to the cooking appliance, and the door is pivotably connected to the cooking appliance.

2. The door movement system of claim 1, wherein the door is pivotable with respect to the cooking appliance between a first closed position where the door is in a substantially vertical position and an open position where the door is in a substantially horizontal position.

3. The door movement system of claim 2, wherein the door passes through an intermediate position when the door pivots between the open and closed positions, wherein the door is biased to move toward the closed position after pivoting past the intermediate position toward the closed position, and the door is biased toward the open position after pivoting past the intermediate position toward the open position.

4. The door movement system of claim 3, wherein the door may be maintained in a stationary position in the intermediate position.

5. The door movement system of claim 4, wherein the door is in the intermediate position when a plane extending through an inner surface of the door is at an angle between about 15 degrees and about 45 degrees from the horizontal.

6. The door movement system of claim 5, wherein the intermediate position is an angle within the range of about 15 degrees to about 25 degrees.

7. The door movement system of claim 5, wherein the intermediate position is an angle within the range of about 35 degrees to about 45 degrees.

8. The door movement system of claim 1, wherein the first end portion of the rod is pivotably secured to a bar, with the door fixed to a bar.

9. The door movement system of claim 8, wherein the biasing member extends within the restraint between the end cap and a bearing surface operatively engaged with the second end portion of the rod.

10. The door movement system of claim 1, further comprising a first pin fixed to the first end portion of the rod, and a second pin that is connected to the door, with each of the first and second pins being fixed to a bar, wherein the first pin orbits around the second pin as the door pivots with respect to the cooking appliance.

11. The door movement system of claim 1, wherein the biasing member extends within the restraint between the end cap and a washer operatively engaged with the second end portion of the rod.

12. The door movement system of claim 1, wherein the system is disposed within a housing of a cooking appliance, wherein the housing includes at least one wall that defines an aperture that the second pin extends therethrough.

13. The door movement system of claim 12, wherein the restraint is pivotably connected to the housing.

14. The door movement system of claim 1, wherein the restraint is a cylinder.

15. The door movement system of claim 1, further comprising a bracket fixed to a housing of the cooking appliance, and a second rod pinned to the bracket, wherein the second rod is engaged with an end of the restraint, such that relative rotation between the second rod and the restraint changes a distance of the end of the restraint from the pinned connection with the bracket.

16. The door movement system of claim 15, wherein the second rod is threadably connected to the end of the restraint.

17. A door movement system for use with a cooking appliance, comprising:
a rod extending between a first end portion and a second end portion;
a restraint receiving the second portion of the rod therein with the first end portion of the rod extending through an end cap of the restraint;
a biasing member disposed within the restraint between the end cap and the second end portion of the rod, wherein the biasing member is in a compressed configuration within the restraint, and wherein the first end portion of the rod is operatively engaged with a door pivotably secured to the cooking appliance, and the door is pivotably connected to the cooking appliance; and
a bracket fixed to a housing of the cooking appliance, and a second rod pinned to the bracket, wherein the second rod is engaged with an end of the restraint, such that relative rotation between the second rod and the restraint changes a distance of the end of the restraint from the pinned connection with the bracket,
wherein the door is pivotable with respect to the cooking appliance between a first closed position where the door is in a substantially vertical position and an open position where the door is in a substantially horizontal position, wherein the door passes through an intermediate position when the door pivots between the open and closed positions, wherein the door is biased to move toward the closed position after pivoting past the intermediate position toward the closed position, and the door is biased toward the open position after pivoting past the intermediate position toward the open position, and wherein the door may be maintained in a stationary position in the intermediate position.

18. The system of claim 17, wherein the biasing member extends within the restraint between the end cap and a washer operatively engaged with the second end portion of the rod.

19. The system of claim 17, wherein the first end portion of the rod is pivotably secured to a bar, with the door fixed to a bar.

20. The system of claim 17, wherein the door is in the intermediate position when a plane extending through an inner surface of the door is at an angle between about 15 degrees and about 45 degrees from the horizontal.
